(19) United States
(12) Patent Application Publication
(10) Pub. No.: US 2007/0179779 A1
(43) Pub. Date: Aug. 2, 2007

(54) Language information translating device and method

(76) Inventors: Takehiko Kagoshima, Kanagawa (JP); Gou Hirabayashi, Kanagawa (JP); Yuji Shimizu, Kanagawa (JP); Dawei Xu, Tokyo (JP)

Correspondence Address: NIXON & VANDERHYE, PC, 901 NORTH GLEBE ROAD, 11TH FLOOR, ARLINGTON, VA, 22203, US

(21) Appl. No.: 11/586,732

(22) Filed: Oct. 26, 2006

(30) Foreign Application Priority Data
Feb. 1, 2006 (JP) 2006-24980

(51) Int. Cl. G06F 17/21

(52) U.S. Cl. 704/10

(57) ABSTRACT

In language information translating device and method, registered vocabulary information pieces of plural users registered into a user dictionary registering unit are referred to, and when plural vocabulary information pieces having the same direction word exist, a direction word to be added to a basic dictionary is extracted on the basis of at least one of the number of registered vocabulary information pieces of the direction word concerned and the number of registered vocabulary information pieces that are registered vocabulary information pieces of the direction word concerned, the second language expressions corresponding to the registered vocabulary information pieces concerned being coincident with one another, and the basic vocabulary information of the extracted direction word is registered in the basic dictionary.

### CROSS-REFERENCE TO RELATED APPLICATIONS

This application is based upon and claims the benefit of priority from the prior Japanese Patent Application No. 2006-24980, filed on Feb. 1, 2006; the entire contents of which are incorporated herein by reference.

### TECHNICAL FIELD

The present invention relates to a language information translation device that converts language information based on some expression to language information based on different expression such as a voice synthesizing device, a Kana-Kanji character translating device, a machine translation device or the like, and particularly to a language information translation device that enables contents registered in a user dictionary to be used by other users when plural users use one system.

### BACKGROUND OF THE INVENTION

A machine translation is a technique of automatically translating an input sentence based on some language to a sentence based on another language. For example, in a Japanese-to-English machine translation for translating Japanese to English, translation from Japanese to English is carried out by referring to a dictionary in which a large number of information pieces on pairs each of which comprises a Japanese word and the corresponding to English word are registered. Likewise, voice synthesis and Kana-Kanji character translation are known in the language information translation technique for translating some language expression to another language expression by referring to a dictionary. The voice synthesis is a technique of artificially creating voice from an input sentence containing mixture of kanji characters and kana characters. In process of voice synthesis, a kana-kanji mixture character array is converted to a pronunciation symbol array. In this case, information on a pair of words expressed by a kanji-kana mixture character array and a pronunciation symbol array is registered in the dictionary. Furthermore, the kana-kanji translation is a technique of translating a kana character array to a kana-kanji mixture character array. In this case, a pair of words expressed by a kana character sequence and a kanji-kana mixture character sequence of the word concerned is registered.

In the language information translation technique, a dictionary in which generally frequently used vocabularies are collected and registered (hereinafter referred to as “basic dictionary”) is prepared in advance. However, when a word non-registered in the basic dictionary such as a technical term, a new word or the like is input, an error may occur in the translation. Therefore, in order to register words which do not exist in the dictionary and achieve a correct translation result, a user dictionary function of enabling user's registration is frequently provided.

There has been hitherto known a technique of enabling plural users jointly own the contents of a user dictionary so that plural users can omit a vain work of registering the same word into their user dictionaries when the plural users utilizes a language information translation device using the language information translation technique as described above. For example, Japanese Application Kokai 11-66059 has disclosed a method of registering into a common dictionary a content which is registered in a user dictionary by a user so that the other users can refer to the common dictionary, whereby the contents of the user dictionaries are commoditized to all the users.

According to the above-described technique, the contents registered in the user dictionary are commoditized without any check. Therefore, when a registration content in the user dictionary is incorrect, the incorrect information is commoditized. As compared with a case where several specified users use a language information device in a company, in such a case that the general public use the language information translation device through a network, user's technique and knowledge level are greatly dispersed among unspecified users, so that there is a high risk that incorrect information is registered in user dictionaries.

### BRIEF SUMMARY OF THE INVENTION

The present invention has been implemented in view of the foregoing problem, and has an object to provide language information translating device and method that statically analyze the contents of user dictionary of many users and extract reliable registration contents to commoditize the registration contents to the users.

According to embodiments of the present invention, a language information translating device that is usable by plural users and translates a first language expression to a second language expression comprises: a user dictionary configured to store registered vocabulary information containing at least a direction word of the first language expression and the second language expression corresponding to the direction word of each registered user; a basic dictionary configured to store basic vocabulary information containing at least a direction word of the first language expression and the second language expression corresponding to the direction word; a language information translating unit configured to refer to the basic vocabulary information of the basic dictionary and registered vocabulary information registered by the user concerned of the user dictionary, and translate input information expressed by the first language expression to the second language expression; an important word extracting unit configured to refer to the registered vocabulary information of the plural user dictionaries and extract a direction word to be added to the basic dictionary on the basis of at least one of the number of registered vocabulary information pieces that are associated with the same direction word and the number of registered vocabulary information pieces that are associated with the same direction word, the corresponding second language expressions of which are also coincident with one another; and a dictionary renewing unit configured to register the registered vocabulary information of the extracted direction word as basic vocabulary information into the basic dictionary.

According to embodiments of the present invention, a language information translating device that is usable by plural users and translates a first language expression to a second language expression comprises: a user dictionary configured to store registered vocabulary information containing at least a direction word of the first language expression and the second language expression corresponding to the direction word of each registered user; a basic dictionary registering unit configured to store basic vocabulary information containing at least a direction word of the first language expression and the second language expression corresponding to the direction word; a common dictionary configured to store common vocabulary information containing at least a direction word of the first language expression and the second language expression corresponding to the direction word; a language information translating unit configured to refer to basic vocabulary information of the basic dictionary, registered vocabulary information registered by the user of the user dictionary concerned and common vocabulary information of the common dictionary indicated by the user to translate input information expressed by the first language expression to the second language expression; an important word extracting unit configured to refer to the registered vocabulary information of the plural user dictionaries and extract a direction word to be added to the common dictionary on the basis of at least one of the number of registered vocabulary information pieces that are associated with the same direction word and the number of registered vocabulary information pieces that are associated with the same direction word, the corresponding second language expressions of which are also coincident with one another; and a dictionary renewing unit configured to register the registered vocabulary information of the extracted direction word as common vocabulary information into the common dictionary.

According to the embodiments of the present invention, reliable contents are extracted from user dictionaries of many users and commoditized, whereby the contents registered by other users can be used to perform high-precision translation without being adversely affected by incorrect registration contents.

### BRIEF DESCRIPTION OF THE DRAWINGS

FIG. 1 is a block diagram showing the construction of a voice synthesizing device according to a first embodiment of the present invention;

FIG. 2 is a flowchart showing the operation of a voice synthesizing unit 11 of the first embodiment;

FIG. 3 is a flowchart showing the operation of an important word extracting unit 16 and a basic dictionary renewing unit 15 according to the first embodiment;

FIG. 4 shows an example of basic vocabulary information of a basic dictionary according to the first embodiment;

FIG. 5 shows an example of registered vocabulary information of a user dictionary according to the first embodiment;

FIG. 6 shows an example of statistic information according to the first embodiment;

FIG. 7 is a block diagram showing the construction of a voice synthesizing device according to a second embodiment;

FIG. 8 is a block diagram showing the construction of a voice synthesizing device according to a third embodiment;

FIG. 9 shows an example of registered vocabulary information of a user dictionary according to the third embodiment;

FIG. 10 shows an example of statistic information according to the third embodiment;

FIG. 11 is a flowchart showing the operation of an important word extracting unit 46 and a dictionary renewing unit 45 according to the third embodiment;

FIG. 12 is a block diagram showing the construction of a machine translating device; and

FIG. 13 is a block diagram showing the construction of a kana-kanji translating device.

### DETAILED DESCRIPTION OF THE INVENTION

Embodiments of the present invention will be described hereunder with reference to the drawings.

### First Embodiment

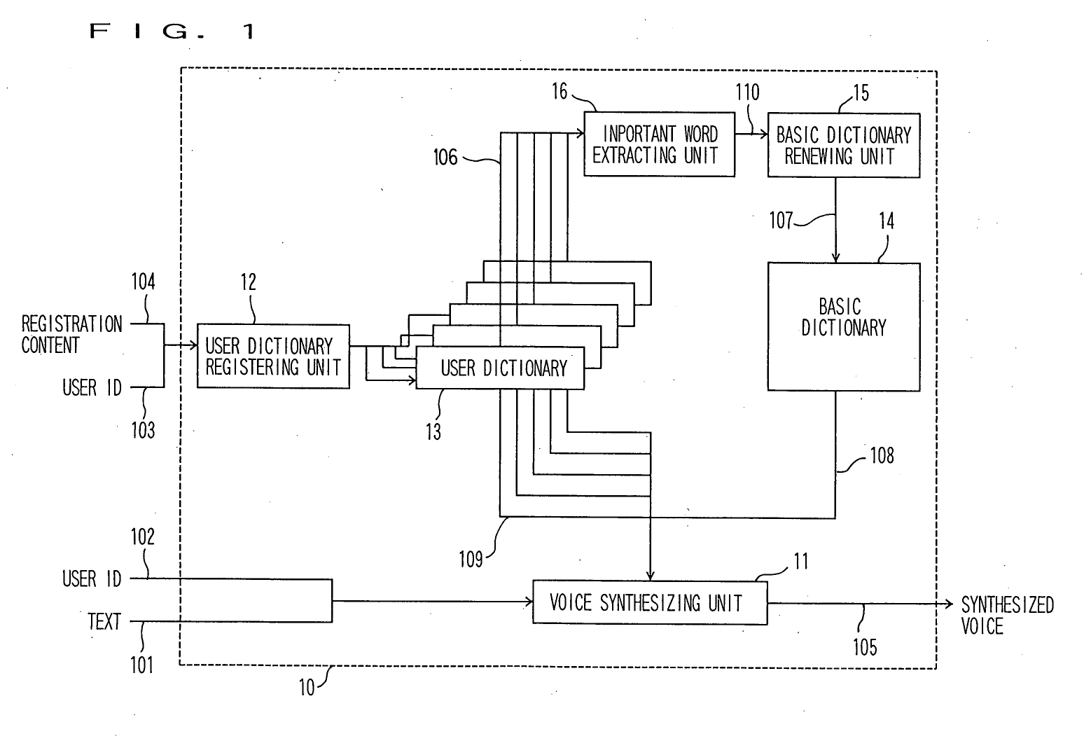

A voice synthesizing device 10 according to a first embodiment of the present invention will be described with reference to FIGS. 1 to 6.

### (1) Construction of Voice Synthesizing Device 10

The voice synthesizing device 10 is equipped with a voice synthesizing unit 11, a basic dictionary 14, user-dictionaries 13, a user dictionary registering unit 12, an important word extracting unit 16 and a basic dictionary renewing unit 15. The voice synthesizing device 10 is used for text-voice translation by plural users, and a user ID is allocated to each user.

The voice synthesizing unit 11 is supplied with an input text 101 and a user ID 102 and refers to basic vocabulary information 108 stored in the basic dictionary 14 and the vocabulary information corresponding to the user ID 102 out of registered vocabulary information 109 stored in the user dictionaries 13 to create synthesized voice 105.

In connection with prepared words, the basic dictionary 14 stores the direction word of each of the words concerned and a set of a pronunciation symbol array, an accent position, a word class, etc. for the word concerned as basic vocabulary information.

In connection with words registered by a user, each user dictionary 13 stores the direction word of each of the words concerned and a set of a pronunciation symbol array, an accent position, a word class, etc. as registered vocabulary information every user. However, the registered vocabulary information and the user ID may be stored as a pair in place of separately storing the registered vocabulary information every user.

A registration content 104 input for dictionary registration by a user is registered as registered vocabulary information in the user dictionary 13 according to the user ID 103 of the user concerned by the user dictionary registering unit 12.

The important word extracting unit 16 refers to the user dictionaries 13 to extract a word to be registered in the basic dictionary 14, and outputs an important word 110.

The basic dictionary renewing unit 15 registers the basic vocabulary information of the extracted important word 110 into the basic dictionary 14.

The voice synthesizing device 10, a machine translating device 71 of a fourth embodiment described later and a kana-kanji translating device 80 may be also implemented by using a general-purpose computer device as a basic hardware.

That is, they may be implemented by making a processor mounted in the computer device execute a program. At this time, the voice synthesizing device 10, the machine translating device 71 and the kana-kanji translating device 80 may be implemented by installing the above program into the computer device in advance, or maybe implemented by storing the program in a storage medium such as CD-ROM or distributing the program through a network and properly installing the program into the computer device. Furthermore, they may be implemented by properly using a built-in memory of the computer device or an external memory, a hard disk or a storage medium such as CD-R, CD-RW, DVD-RAM, DVD-R or the like.

### (2) Operation of Voice Synthesizing Unit 11

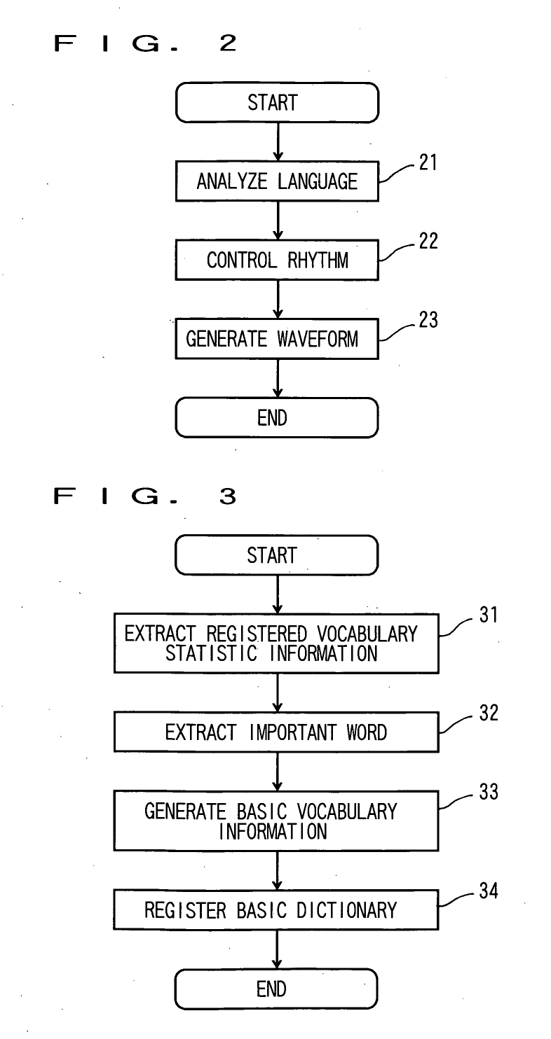

Next, the operation of the voice synthesizing unit 11 will be described with reference to FIGS. 1 and 2.

When a text 101 is input to the voice synthesizing unit 11, in a language analysis step 21 of FIG. 2, a registered vocabulary corresponding to the user ID 102 out of the basic dictionary 14 and the user dictionary 13 is referred to, and a reading (pronunciation), a break position of a syllable (accent phrase), an accent position of the text are output.

Next, in a rhythm control step 22, rhythm information such as a basic frequency pattern representing the time variation of pitch of a voice, a phoneme continuing time length representing the length of each phoneme, the position and length of pause (cease), etc. is output from the above information.

Finally, in a waveform generating step 23, voice pieces as voice signals in short sections such as phonemes, syllables or the like are connected to one another according to pronunciation information, and at the same time the pitch and length of a voice are varied according to the rhythm information, thereby outputting a synthesized voice 105.

### (3) Operation of Language Analysis Step 21

Here, the operation of the language analysis step 21 described above will be described in detail by exemplifying a case where “watashino jushowa miyagiken tomegun toyomamachidesu (my address is Toyoma-machi, Tome-gun, Miyagi-ken)” is input as a text 101.

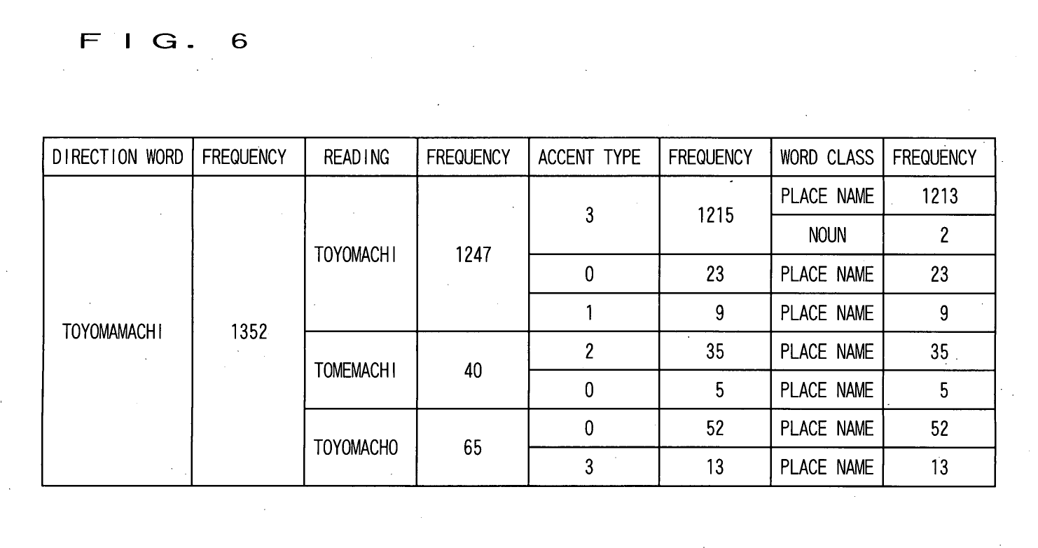

As shown in FIG. 4, a direction word, a reading, an accent type (the position of an accented syllable) and a word class for each word are registered in the basic dictionary 14. It is assumed that the basic dictionary 14 has no the direction word for “toyomamachi” and also nothing is registered in the user dictionary. In this case, the output is “watashino/ju'showa/miyagi'ken/tome'gun/tome'chodesu”. Here, the character arrays of katakana characters (Roman characters) represent the pronunciations, the slash “/” represents the break positions of syllables and single quotations represent the accent positions.

In this case, the reading of is “tomecho” is different from “toyomamachi” whichi is correct.

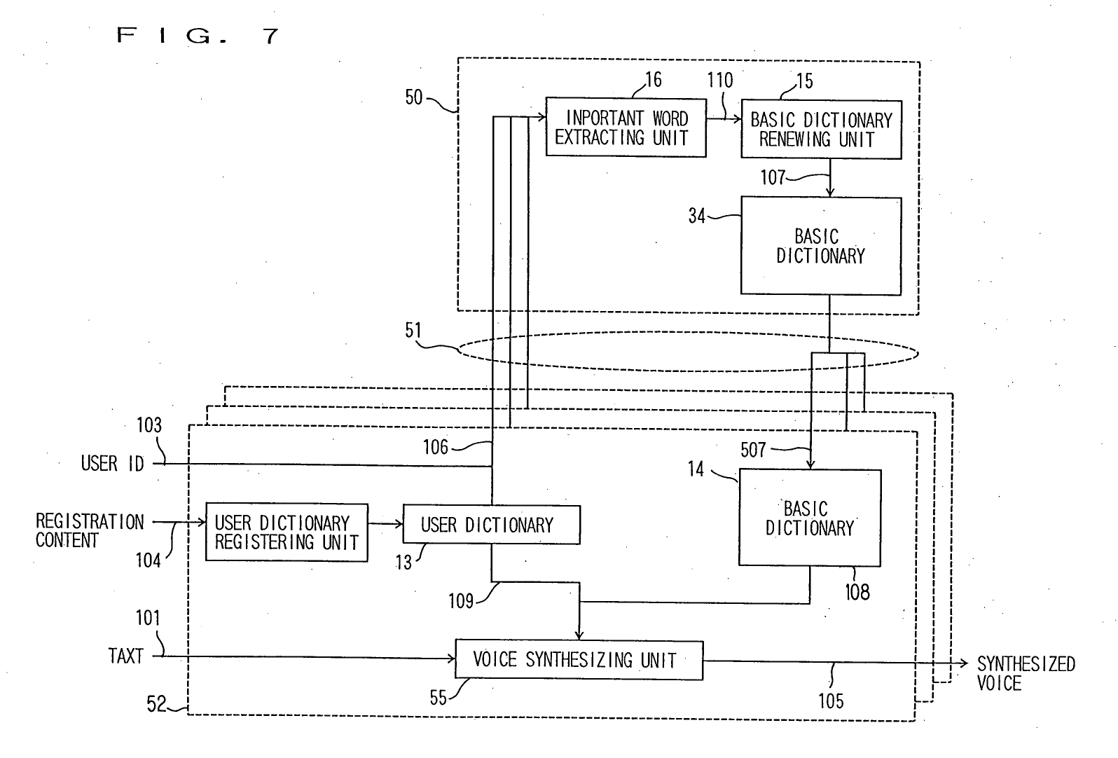

Therefore, when the content shown in FIG. 5 is registered in the user dictionary 13 to make the readings and the accents correct, the output becomes “watashino/ju'showa/miyagi'ken/tome'gun/toyomalmachi”, and a desired result is achieved.

The information of the content shown in FIG. 5 and the user ID are registered into the user dictionary registering unit 12, and the user dictionary registering unit 12 registers the input content into the user dictionary corresponding to the user ID concerned, thereby registering the content shown in FIG. 5 into the user dictionary 13. The input of the reading and the accent type may be carried out by using a reading symbol array and an accent symbol like “toyomalmachi”, and then the reading symbol array and the accent symbol may be converted to information of the reading and the accent type in the user dictionary registering unit 12 and registered.

### (4) Operation of Important Word Extracting Unit 16 and Basic Dictionary Renewing Unit 15

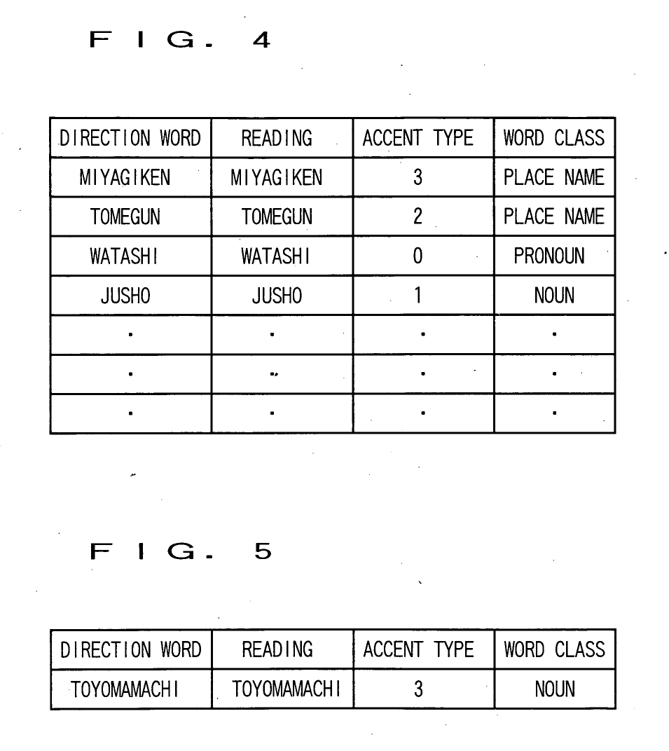

Next, the operation of the important word extracting unit 16 and the basic dictionary renewing unit 15 according to this embodiment will be described with reference to FIGS. 1 and 3.

First, in the important word extracting unit 16, a registered vocabulary statistic information extracting step 31 and an important word extracting step 32 are executed, and the important word 110 is extracted.

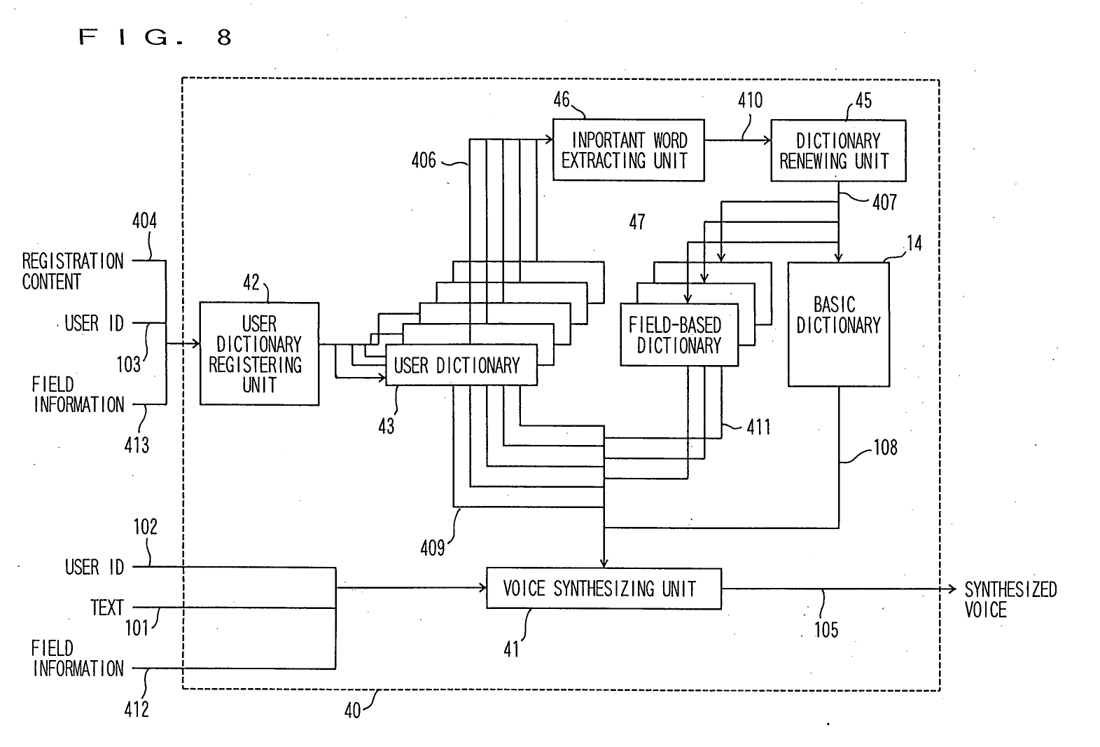

In the registered vocabulary statistic information extracting step 31, the user dictionaries 13 of all the users are checked, and when there are plural vocabularies whose direction words are identical to one another, statistic information associated with the direction word is calculated. FIG. 6 shows an example of the statistic information on the direction word “toyomamachi”. It is apparent from FIG. 6 that there are 1352 entries for the direction word “toyomamachi” in the user dictionary 13, and three kinds of readings “toyomamachi”, “tomemachi” and “toyomacho” are registered as reading information. Furthermore, appearing accent types and word classes are listed up for each reading, and the appearing frequencies thereof are counted. As a criterion of judgment may be used a rule based on the frequencies or rates of the direction word, the reading, the accent type and the word class and the frequencies and rates of the combinations of these factors. For example, the following rules or a rule described by the following rule described by the combination of these rules may be used.
(1) The frequency of the direction word is 1000 or more.
(2) The maximum frequency of the combination of the direction word and the reading is 800 or more.
(3) The maximum frequency of the combination of the direction word, the reading and the accent type is 700 or more.
(4) The rate of the maximum frequency of the reading occupied in the frequency of the direction word is 80% or more.
(5) The word class of the maximum frequency is a place name or person name.

For example, if it is defined as a condition for an important word that all the conditions (1), (3) and (5) are satisfied, “toyomamachi” of FIG. 6 satisfies all the conditions, and thus it is extracted as an important word. In place of this, a judging rule for important words may be described by checking whether a direction word has been already registered in the basic dictionary 14. Furthermore, a system manager may check the statistic information to make a final judgment as to whether a word is judged as an important word.

Next, in the basic dictionary renewing unit 15, the basic vocabulary information generating step 33 and the basic dictionary registering step 34 are executed, and the important word 110 is registered in the basic dictionary 14. In the basic vocabulary information generating step 33, the information on the direction word, the reading, the accent type and the word class is generated by referring to the statistic information.

For example, in the case of “toyomamachi” of FIG. 6, if the combination having the maximum frequency is selected from the combinations of the direction words, the readings, the accent types and the word classes, the basic vocabulary information is “direction word: toyomamachi, reading: toyomamachi, accent type: 3, word class: place name”.

Here, the reading and the accent type have dependency relationship with each other, however, the word class and other information have no dependency relationship. Therefore, the reading and the accent type may be determined on the basis of the frequency of the combination of the direction word, the reading and the accent type while the word class is determined on the basis of the frequency of the combination of the direction word and the word class.

Furthermore, the system manager may be allowed to check and amend the created content.

Even when the basic vocabulary information of a correct content is added, there is a probability that a translation error is increased by side-effects. Therefore, an effect which will be caused by adding the basic vocabulary information is investigated in advance, and when an adverse effect is great, the registration may be ceased. For example, a translation result of readings and accent positions is generated from a lot of texts in advance. Furthermore, basic vocabulary information is added and a translation result of the same text is achieved. Then, the difference between the translation results before and after the basic vocabulary information is added is extracted, and it is checked on the basis of the extracted difference whether there is any adverse effect.

Subsequently, in the basic dictionary registering step 34, the basic vocabulary information 107 thus generated is registered in the basic dictionary 14. At this time, the registered vocabulary information having the same content as the registered basic vocabulary information 107 may be deleted from the user dictionary.

As described above, the renewal of the basic dictionary 14 by the important word extracting unit 16 and the basic dictionary renewing unit 15 may be executed at a fixed time interval such as every day or every week, or every time the number of registered words of the user dictionary is increased by a fixed number such as 100 words, 1000 words or the like. Furthermore, it maybe executed by the system manager as occasion demands.

### (5) Effect

As described above, according to the voice synthesizing device 10 of this embodiment, the important word is extracted by referring to the statistic information of the word registered in the user dictionary. Therefore, generally-unused special terms and incredible terms because they are frequently erroneously registered or the readings thereof do not become established can be prevented from being registered in the basic dictionary, and thus only useful and credible words can be registered in the basic dictionary. Accordingly, all the users can effectively use the registration contents of the user dictionaries.

### (6) Modification

In the important word extracting step 32 under the operation of the important word extracting portion 16 described above, users who have registered direction words extracted as important words may be searched to count the number of registration cases of the important words every user.

Furthermore, the basic vocabulary information generated in the basic vocabulary information generating step 33 under the operation of the basic dictionary renewing unit 15, and the registered vocabularies among which not only the direction words, but also the readings, the accent types and the word classes are coincident may be counted. The number of the registration cases thus counted represents the contribution to the renewal of the basic dictionary, and thus it can be regarded as a contribution degree of each user. Therefore, if an incentive such as an article of commerce, an award or a point exchangeable with the article of commerce or the award is given to each user in accordance with the contribution degree of the user, the user dictionary registration is further promoted, so that the vocabularies of the basic dictionary is enriched.

Furthermore, in the registered vocabulary statistic information extracting step 31 under the operation of the important word extracting unit 16, when the statistic information is calculated, the above contribution degree may be weighted to calculate the frequency thereof. Through this weighting operation, much value is placed on a registration content of a credible user having a higher contribution degree, so that the precision of the important word extraction can be enhanced.

### Second Embodiment

Next, a voice synthesizing device 52 and a dictionary renewing device 50 according to a second embodiment of the present invention will be described with reference to FIG. 7.
(1) Construction of Voice Synthesizing Device 52 and Dictionary Renewing Device 50

FIG. 7 is a block diagram showing the voice synthesizing device 52 and the dictionary renewing device 50.

In this embodiment, the voice synthesizing device 52 of each user is connected to one dictionary renewing device 50 through a network 51.
(2) Operation of Voice Synthesizing Device 52 and Dictionary Renewing Device 50

The operation of this embodiment will be described while concentrating on the different point from the first embodiment. In this embodiment, one voice synthesizing device 52 is used by a specific user and thus the user ID is unnecessary for user dictionary registration and voice synthesis.

Only registered words of the user concerned are registered in the user dictionary 13. In the voice synthesizing unit 55, all the registered words of the basic dictionary 14 and the user dictionary 13 are referred to, and a synthesized voice 105 is generated from a text 101.

Next, the operation of the dictionary renewing device 50 will be described.

The important word extracting unit 16 refers to the registered vocabulary information 106 of the user dictionary 13 of each user through the network 51, and an important word 110 is extracted according to the same procedure as the first embodiment.

The basic dictionary renewing unit 15 also generates the basic vocabulary information 107 according to the same procedure as the first embodiment, and renews the basic dictionary 54. In the dictionary renewing device 50, the user ID 103 may be referred to through the network 51 in order to calculate and use the user contribution degree.

Here, the voice synthesizing device 52 accesses the basic dictionary 54 of the dictionary renewing device 50 through the network 51, and renews the basic dictionary 14. The basic dictionary 14 is renewed periodically, for example, everyday or every week, or it may be renewed when the basic dictionary 54 is renewed. Or, the user may renew the basic dictionary 14 at any timing.

### (3) Effect

According to this embodiment, there is an effect that a standby time required from input of a text till output of a voice is shortened because the user carries out voice synthesis by occupying a voice synthesizing device beside him/her. Furthermore, a server which is commonly used by many users carries out only dictionary renewal, and thus the processing load is lightened.

### (4) Modification

In the above embodiment, the important word extracting unit 16 refers to the registered vocabulary information 106 of the user dictionary 13 of each user through the network 51. However, each user may upload the registered vocabulary information of the user dictionary 13 through the network and stored a copy of the user dictionary 13 into the dictionary renewing device 50. This construction brings an effect that an access through the network is not required when the dictionary renewal is carried out, so that the load of the network is reduced and also the time of the dictionary renewal is shortened.

### Third Embodiment

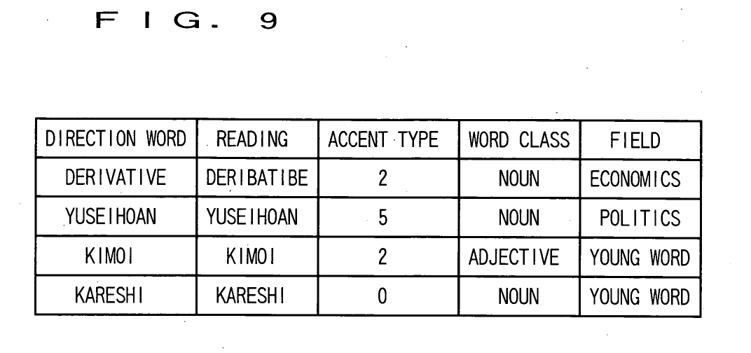

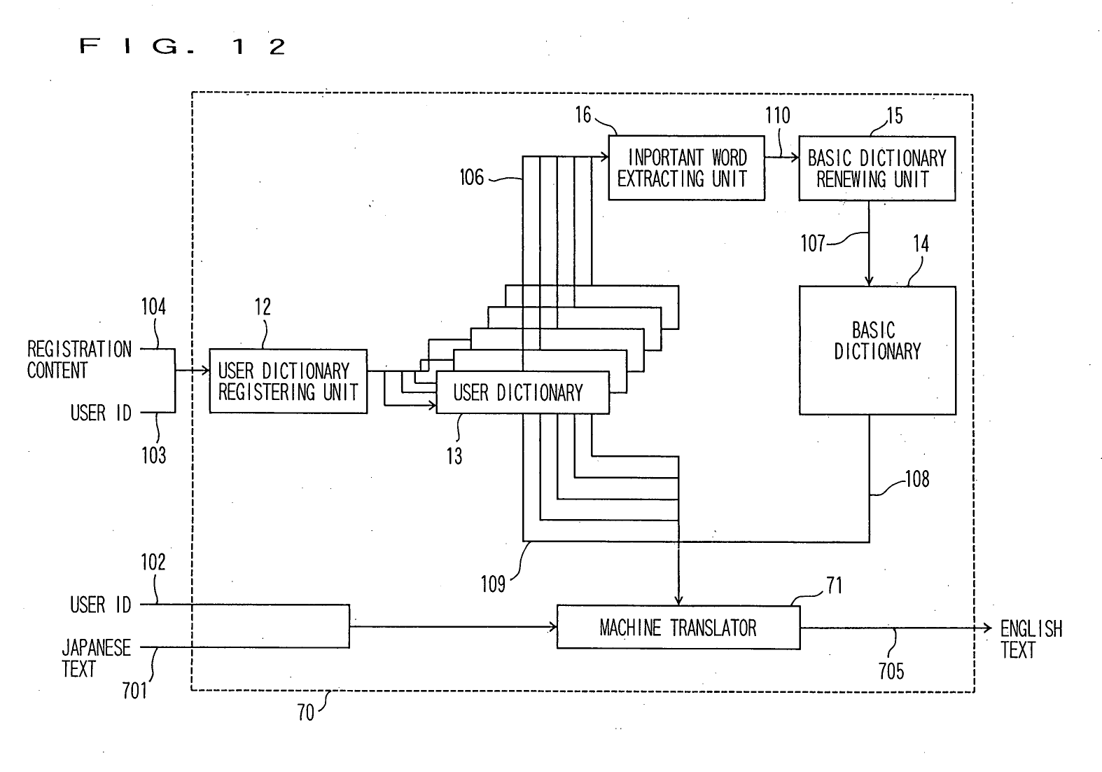

Next, a voice synthesizing device 40 according to a third embodiment will be described with reference to FIGS. 8 to 11.

### (1) Construction of Voice Synthesizing Device

FIG. 8 is a block diagram showing a voice synthesizing device 40.

This embodiment is different from the first embodiment in that a field-based (sectoral) dictionary 47 is provided and an important word extracted from a user dictionary is registered in the basic dictionary or the field-based dictionary.

### (2) Operation of Voice Synthesizing Device 40

The operation of this embodiment will be described while concentrating on the different point from the first embodiment.

For each word used frequently in each field, the field-based dictionary 47 stores as field-based vocabulary information a set of the direction word, the pronunciation symbol array, the accent position, the word class, etc. of the word concerned.

Genres of news such as politics, economics, sports, entertainment, computer, oversea, etc. may be sued as fields. Furthermore, “wakamono kotoba (young words)”, etc. whose vocabularies and accents are different from hitherto-known Japanese words may be used as fields.

The basic operation of the voice synthesizing unit 41 is the same as the voice synthesizing unit 11 of the first embodiment shown in FIG. 2. However, according to this embodiment, in addition to the user ID 102 and the text 101, field information 412 is input. In the language analysis step 21, in addition to the registered vocabulary corresponding to the user ID 102 out of the basic dictionary 14 and the user dictionaries 13, the field-based dictionary 47 indicated by the field information 412 is referred to and the reading (pronunciation), the break position of the syllable (accent phrase) and the accent position of the text 101 are output.

For a word registered by the user, the user dictionary 43 stores as registered vocabulary information a set of the direction word, the pronunciation symbol array, the accent position, the word class, the field information, etc. of the word concerned every user.

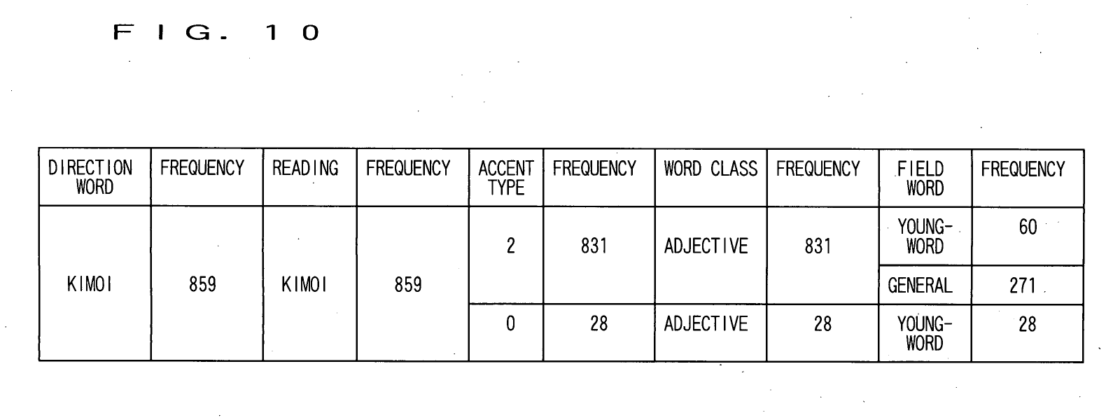

The registration content 104 and the field information 413 input for dictionary registration by a user are registered as registered vocabulary information in the user dictionary 43 according to the user ID 103 of the user concerned by the user dictionary registering unit 42. FIG. 9 shows an example of the user dictionary 43. In this example, a word “kareshi (boy friend)” is a direction word which also exists in the basic dictionary 14, however, it is registered in the user dictionary because the accent type thereof is different from a normal one.

### (3) Operation of the Important Word Extracting Unit 46 and Dictionary Renewing Unit 45

Next, the operation of the important word extracting unit 46 and the dictionary renewing unit 45 of this embodiment will be described with reference to FIGS. 8 to 11.

First, in the important word extracting unit 46, a registered vocabulary statistic information extracting step 61 and an important word extracting step 62 are executed to extract an important word 410.

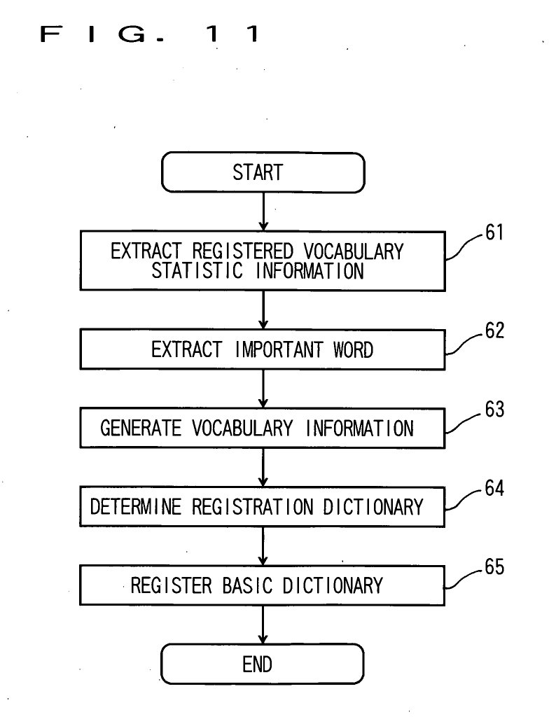

In the registered vocabulary statistic information extracting step 61, the user dictionaries 43 of all the uses are checked, and when there are plural registered vocabularies having the same direction word, the statistic information on the direction word concerned is calculated. FIG. 10 shows an example of the statistic information for a direction word “kimoi (disgusting)”. In addition to the statistic information of the first embodiment, the statistic calculation for the field information is also carried out.

Subsequently, in the important word extracting step 32, the statistic information is referred to, and then it is judged whether the extracted direction word “kimoi” should be set as an important word. The judgment criteria is the same as the first embodiment, however, for example, the following rule-associated with the field may be used.

1) The maximum frequency of the combination of the direction word, the reading, the accent type and the field is above 500.

2) The rate of the maximum frequency of the field occupying the frequency of the direction word is above 50%.

Furthermore, the judgment rule of the important word may be described by checking whether the direction word has been already registered in the basic dictionary 14 or the field-based dictionary 47.

Still furthermore, the system manager may check the statistic information to make a final judgment as to whether the word is set as an important word.

Subsequently, in the dictionary renewing unit 45, a vocabulary information generating step 63, a registration dictionary determining step 64 and a dictionary registering step 65 are executed, and an important word 410 is registered in the basic dictionary 14 or the field-based dictionary 47.

In the vocabulary information generating step 63, the static information is checked to generate information on the direction word, the reading, the accent type and the word class as vocabulary information 407. For example, in the case of “kimoi” in FIG. 10, if the combination having the maximum frequency is selected from the combinations of the direction word, the reading, the accent type and the word class, the basic vocabulary information is “direction word: kimoi, reading: kimoi, accent type: 2, word class: adjective”.

Here, the reading and the accent type have the dependency relationship, however, the word class has no relationship with other information. Therefore, the reading and the accent type may be determined by the frequency of the combination of the direction word, the reading and the accent type and also the word class may be determined by the frequency of the combination of the direction word and the word class.

Furthermore, the content generated by the system manager may be checked and corrected.

In the registration dictionary determining step 64, the statistic information is checked to determine a dictionary in which generated vocabulary information is registered. For example, if most of the field information corresponding to the generated vocabulary information is coincident with one another in the statistic information, the corresponding field of the field-based dictionary 47 may be registered.

Furthermore, when the field information corresponding to the generated vocabulary information is dispersed and thus it is not settled to any fixed field or when the field information concentrates on “general”, the generated vocabulary information may be registered in “general” field” of the field-based dictionary 47, or registered in the basic dictionary 14. Selection of one of the field-based dictionary 47 and the basic dictionary 14 may be carried out like the basic dictionary is selected when the frequency of the direction word is larger than a fixed number and the field-based dictionary is selected in the other cases, or the word class may be checked to select the basic dictionary when it is associated with noun and the field-based dictionary in the other cases. Furthermore, the system manager may check and correct the dictionary in which the generated vocabulary information should be registered.

In a dictionary registering step 65, the generated vocabulary information 407 is registered in the determined (selected) registration dictionary. When it is registered in the basic dictionary, the registered vocabulary information having the same content as the registered vocabulary information 407 may be deleted from the user dictionary.

The renewal of the dictionary by the important word extracting unit 46 and the dictionary renewing unit 45 as described above may be executed at a fixed time interval, for example, everyday, every week or the like, or it may be executed every time the number of registered words in the user dictionary is increased by a fixed number such as 100 words, 1000 words or the like. The system manager may also execute the renewal in other cases as occasion demands.

### (4) Effect

As described above, according to the voice synthesis device 40 of this embodiment, a word extracted from a user dictionary is registered in the field-based dictionary, and a user can select a field to be used. Accordingly, a synthesized voice having proper reading and accent can be generated by using a dictionary matched with the content of a text for voice synthesis.

### (5) Modification

In this embodiment, the important words extracted from the user dictionaries are classified on the basis of the field information input by the users, and registered in plural field-based dictionaries. However, the method of classifying the extracted important word is not limited to the above embodiment, and they may be classified by various methods and jointly used among users. For example, on the basis of the frequency of the extracted direction word, it may be classified and registered into “high-reliability dictionary” when the frequency of the direction word concerned is above 10,000, to “middle-reliability dictionary” when the frequency of the direction word concerned is above 3000, and to “low reliability dictionary” when the frequency of the direction word concerned is above 1000, and the users may select whether they use these dictionaries. By the above classifying method, the proper dictionary can be selected in accordance with the range of the vocabularies to be used, for example, when special vocabularies are frequently used, all the dictionaries are used to increase the number of vocabularies although the reliability is low, or when only general terms are used, only the high-reliability dictionary is used.

### Fourth Embodiment

The three embodiments of the voice synthesizing device have been described, however, the present invention is not limited to the voice synthesis device. For example, the same three embodiments may be applied to a machine translation device and a kana-kanji character translating device.

### (1) Machine Translation Device 70

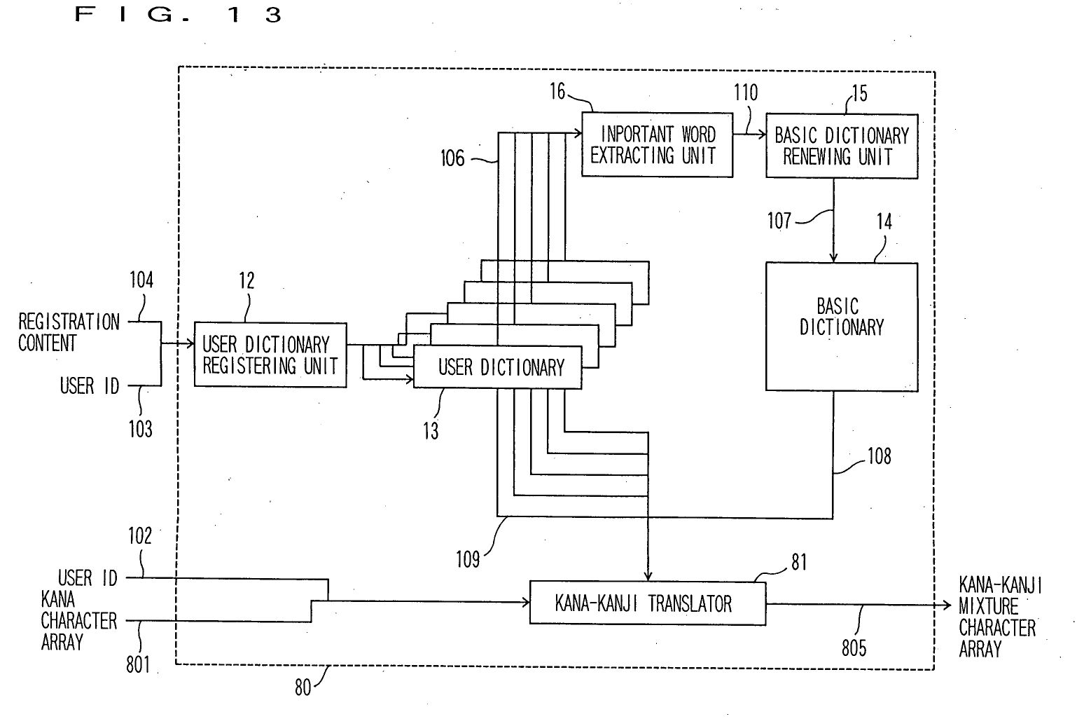

A machine translation device 70 will be described with reference to FIG. 12.

In the machine translation device 70 shown in FIG. 12, the voice synthesizing unit 11 of the voice synthesizing device serves as a machine translator 71, and it translates an input Japanese text 701 into English and outputs an English text 705.

The registration contents of the basic dictionary 14 and the user dictionary 13 are Japanese direction words and the English translations thereof.

The operation of the other portions are the same as the voice synthesizing device, and an important word is extracted by checking the statistic information of a word registered in the user dictionary, whereby a generally-unused special term and an incredible term which is incredible because it is frequently incorrectly registered or the correct translation thereof has not been established can be prevented-from being registered in the basic dictionary. Therefore, only useful and credible words can be registered in the basic dictionary.

As described above, as in the case of the first embodiment, the second and third embodiments may be implemented as the machine translating device, and the same effect as the voice synthesizing device can be achieved.

### (2) Kana-Kanji Character Translating Device 80

A kana-kanji character translating device 80 will be described with reference to FIG. 13.

In the kana-kanji character translating device 80 according to the first embodiment of the present invention shown in FIG. 13, the voice synthesizing unit 11 of the voice synthesizing device serves as a kana-kanji character translator 81. An input kana character array 801 is subjected tokana-kanji character translation and a kana-kanji mixture character array 805 is output.

Furthermore, the registration contents of the basic dictionary 14 and the user dictionary 13 are a direction word of a kana character array and the kana-kanji mixture character array corresponding to the direction word.

The operation of the other portions is the same as the voice synthesizing device or the machine translating device. The statistic information of the word registered in the user dictionary is checked to extract an important word, whereby a generally-unused term and a term which is incredible because it is frequently incorrectly registered or a correct kanji expression has not been established are prevented from being registered in the basic dictionary, and only useful and credible terms can be registered in the basic dictionary.

This embodiment is not limited to Japanese kana-kanji character translation, but it may be applied to translation from an expression which can be input by a keyboard into a proper expression based on a language such as Kanji or the like, for example, Pinyin-kanji character translation of Chinese.

As in the case of the first embodiment, the second and third embodiments maybe implemented as the kana-kanji character translating device, and the same effect as the voice synthesizing device can be achieved.

### (Modification)

The present invention is not limited to the above embodiments, and the constituent elements thereof may be modified at the implementing stage without departing from the subject matter of the present invention.

Furthermore, various embodiments of the present invention may be made by properly combining plural constituent elements disclosed in the above-described embodiments. For example, some constituent elements maybe omitted from all the constituent elements disclosed in the embodiments.

Furthermore, the constituent elements over different embodiments may be properly combined.

What is claimed is:

1. A language information translating device that is usable by plural users and translates a first language expression to a second language expression comprising:
a user dictionary configured to store registered vocabulary information containing at least a direction word of the first language expression and the second language expression corresponding to the direction word of each registered user;
a basic dictionary configured to store basic vocabulary information containing at least a direction word of the first language expression and the second language expression corresponding to the direction word;
a language information translating unit configured to refer to the basic vocabulary information of the basic dictionary and registered vocabulary information registered by the user of the user dictionary, and translate input information expressed by the first language expression to the second language expression;
an important word extracting unit configured to refer to the registered vocabulary information of the plural user dictionaries and extract a direction word to be added to the basic dictionary on the basis of at least one of the number of registered vocabulary information pieces that are associated with the same direction word and the number of registered vocabulary information pieces that are associated with the same direction word, the corresponding second language expressions of which are also coincident with one another; and
a dictionary renewing unit configured to register the registered vocabulary information of the extracted direction word as basic vocabulary information into the basic dictionary.

2. A language information translating device that is usable by plural users and translates a first language expression to a second language expression comprising:
a user dictionary configured to store registered vocabulary information containing at least a direction word of the first language expression and the second language expression corresponding to the direction word of each registered user;
a basic dictionary registering unit configured to store basic vocabulary information containing at least a direction word of the first language expression and the second language expression corresponding to the direction word,
a common dictionary configured to store common vocabulary information containing at least a direction word of the first language expression and the second language expression corresponding to the direction word;
a language information translating unit configured to refer to basic vocabulary information of the basic dictionary, registered vocabulary information registered by the user of the user dictionary concerned and common vocabulary information of the common dictionary indicated by the user, and translate input information expressed by the first language expression to the second language expression;
an important word extracting unit configured to refer to the registered vocabulary information of the plural user dictionaries and extract a direction word to be added to the common dictionary on the basis of at least one of the number of registered vocabulary information pieces that are associated with the same direction word and the number of registered vocabulary information pieces that are associated with the same direction word, the corresponding second language expressions of which are also coincident with one another; and
a dictionary renewing unit configured to register the registered vocabulary information of the extracted direction word as common vocabulary information into the common dictionary.

3. The device according to claim 1, wherein the important word extracting unit extracts a direction word when the number of registered vocabulary information pieces having the same direction word or the number of registered vocabulary information pieces that are the registered vocabulary information pieces having the same direction word, the second language expressions corresponding to the registered vocabulary information pieces concerned being coincident with one another, is equal to a threshold value or more.

4. The device according to claim 2, wherein the important word extracting unit extracts a direction word when the number of registered vocabulary information pieces the same direction word or the number of registered vocabulary information pieces that are the registered vocabulary information pieces having the same direction word, the second language expressions corresponding to the registered vocabulary information pieces concerned being coincident with one another, is equal to a threshold value or more.

5. The device according to claim 1, wherein the important word extracting unit, the basic dictionary registering unit and the dictionary renewing unit connected to the user dictionary registering unit and the language information translating unit through a network.

6. The device according to claim 2, wherein the important word extracting unit, the basic dictionary registering unit and the dictionary renewing unit connected to the user dictionary registering unit and the language information translating unit through a network.

7. The device according to claim 1, wherein the common dictionary registering unit is provided every field.

8. The device according to claim 2, wherein the common dictionary registering unit is provided every field.

9. The language information translating device according to claim 1, wherein the important word extracting unit further calculates a user contribution degree corresponding to the number of registered vocabulary information pieces extracted as important words out of registered vocabulary information pieces registered by a user every user.

10. The device according to claim 2, wherein the important word extracting unit further calculates a user contribution degree corresponding to the number of registered vocabulary information pieces extracted as important words out of registered vocabulary information pieces registered by a user every user.

11. The device according to claim 9, wherein the important extracting unit further extracts a direction word to be added on the basis of the user contribution degree.

12. The device according to claim 10, wherein the important extracting unit further extracts a direction word to be added on the basis of the user contribution degree.

13. The device according to claim.1, wherein the second language expression contains at least a pronunciation symbol array corresponding to the corresponding first language expression.

14. The device according to claim 2, wherein the second language expression contains at least a pronunciation symbol array corresponding to the corresponding first language expression.

15. The device according to claim 1, wherein the language based on the first language expression is different from the language based on the second language expression.

16. The device according to claim 2, wherein the language based on the first language expression is different from the language based on the second language expression.

17. The device according to claim 1, wherein the first language expression is a pronunciation symbol array or a kana character array, and the second language expression is any one of a kanji character array, a kanji-kana mixture character array and a word array.

18. The device according to claim 2, wherein the first language expression is a pronunciation symbol array or a kana character array, and the second language expression is any one of a kanji character array, a kanji-kana mixture character array and a word array.

19. A language information translating method that is usable by plural users and translates a first language expression to a second language expression, comprising:
storing registered vocabulary information containing at least a direction word of the first language expression and the corresponding second language expression into a user dictionary of each registered user;
storing basic vocabulary information containing at least a direction word of the first language expression and the corresponding second language expression into a basic dictionary;
translating input information expressed with the first language expression to the second language expression by referring to basic vocabulary information of the basic dictionary and registered vocabulary information registered by the user of the user dictionary concerned;
referring to registered vocabulary information of the plural user dictionaries and extracting a direction word to be added to the common dictionary on the basis of at least one of the number of registered vocabulary information pieces having the same direction word and the number of registered vocabulary information pieces that are registered vocabulary information pieces having the same direction word, the second language expressions corresponding to the registered vocabulary information pieces concerned being coincident with one another; and
registering the registered vocabulary information of the extracted direction word as basic vocabulary information into the basic dictionary.

20. A language information translating method that is usable by plural users and translates a first language expression to a second language expression, comprising:
storing registered vocabulary information containing at least a direction word of the first language expression and the corresponding second language expression into a user dictionary of each registered user;
storing basic vocabulary information containing at least a direction word of the first language expression and the corresponding second language expression into a basic dictionary;
storing common vocabulary information containing at least a direction word of the first language expression and the corresponding second language expression into one or more common dictionaries;
translating input information expressed with the first language expression to the second language expression by referring to basic vocabulary information of the basic dictionary, registered vocabulary information registered by the user of the user dictionary concerned and the common vocabulary information of the common dictionary indicated by the user;
referring to registered vocabulary information of the plural user dictionaries and extracting a direction word to be added to the common dictionary on the basis of at least one of the number of registered vocabulary information pieces having the same direction word and the number of registered vocabulary information pieces having the same direction word, the second language expressions corresponding to the registered vocabulary information pieces concerned being coincident with one another; and
registering the registered vocabulary information of the extracted direction word as common vocabulary information into the common dictionary.

21. A language information translating program product that is usable by plural users and translates a first language expression to a second language expression, the program product comprising instructions of:
storing registered vocabulary information containing at least a direction word of the first language expression and the corresponding second language expression into a user dictionary of each registered user;
storing basic vocabulary information containing at least a direction word of the first language expression and the corresponding second language expression into a basic dictionary;
translating input information expressed with the first language expression to the second language expression by referring to basic vocabulary information of the basic dictionary and registered vocabulary information registered by the user of the user dictionary concerned;
referring to registered vocabulary information of the plural user dictionaries and extracting a direction word to be added to the common dictionary on the basis of at least one of the number of registered vocabulary information pieces having the same direction word and the number of registered vocabulary information pieces that are registered vocabulary information pieces having the same direction word, the second language expressions corresponding to the registered vocabulary information pieces concerned being coincident with one another; and
registering the registered vocabulary information of the extracted direction word as basic vocabulary information into the basic dictionary.

22. A language information translating program product that is usable by plural users and translates a first language expression to a second language expression, the program product comprising instructions of:
storing registered vocabulary information containing at least a direction word of the first language expression and the corresponding second language expression into a user dictionary of each registered user;
storing basic vocabulary information containing at least a direction word of the first language expression and the corresponding second language expression into a basic dictionary;
storing common vocabulary information containing at least a direction word of the first language expression and the corresponding second language expression into one or more common dictionaries;
translating input information expressed with the first language expression to the second language expression by referring to basic vocabulary information of the basic dictionary, registered vocabulary information registered by the user of the user dictionary concerned and the common vocabulary information of the common dictionary indicated by the user;
referring to registered vocabulary information of the plural user dictionaries and extracting a direction word to be added to the common dictionary on the basis of at least one of the number of registered vocabulary information pieces having the same direction word and the number of registered vocabulary information pieces that are registered vocabulary information pieces having the same direction word, the second language expressions corresponding to the registered vocabulary information pieces concerned being coincident with one another; and
registering the registered vocabulary information of the extracted direction word as common vocabulary information into the common dictionary.

23. The device according to claim 1, further comprising:
a user dictionary registering unit configured to register the registered vocabulary information into the user dictionary corresponding to a user ID.

24. The device according to claim 2, further comprising:
a user dictionary registering unit configured to register the registered vocabulary information into the user dictionary corresponding to a user ID.
